(19) United States
(12) Patent Application Publication
(10) Pub. No.: US 2014/0320356 A1
(43) Pub. Date: Oct. 30, 2014

(54) AIRPLANE PATCH ANTENNA

(71) Applicant: ICF INTERNATIONAL, INC., Fairfax, VA (US)

(72) Inventor: Donald M. Bishop, Ashburn, VA (US)

(21) Appl. No.: 14/212,405

(22) Filed: Mar. 14, 2014

Related U.S. Application Data
(60) Provisional application No. 61/782,428, filed on Mar. 14, 2013.

(51) Int. Cl. H01Q 1/28; B32B 33/00

(52) U.S. Cl. CPC H01Q 1/287; B32B 33/00
USPC 343/705; 29/428; 29/458; 156/278

(57) ABSTRACT

Disclosed is a patch antenna that is formed on the surface of an airplane. The patch antenna has a thickness that is sufficiently small, so that the aerodynamic shape of the airplane is not significantly affected. An insulating layer is disposed on the body of the airplane and antenna elements are then placed on the insulating layer. Various frequencies can be either received or transmitted by using antenna elements of various sizes. The body of the airplane is used as a ground plane for the antenna array. When multiple antenna arrays are utilized, antenna elements at the same frequency can generate a lobe that can be directed in different directions using phase changes. Various techniques can be used for applying the insulating layers to the airplane and forming the antenna elements on the insulating layers.

### CROSS-REFERENCE TO RELATED APPLICATION

This application is a non-provisional application of U.S. Patent Application Ser. No. 61/782,428, entitled “Airplane Patch Antenna,” filed by Donald M. Bishop on Mar. 14, 2013. The entire contents of the above mentioned application are hereby specifically incorporated herein by reference for all they disclose and teach.

### BACKGROUND

Antenna systems provide the interface for both transmission and reception of radio frequency signals. Radio frequency signals cover a broad radio frequency spectrum, such that antennas can vary in size. Antennas may be full wave, half wave, quarter wave, or other fractional sizes of the particular wavelength of the frequency transmitted or detected. In addition, there are various types of antennas ranging in sizes and shapes. Antenna technology is a highly specialized art that requires a high degree of expertise to obtain efficient, workable antenna systems.

### SUMMARY

An embodiment of the present invention may comprise a patch antenna on an airplane that does not substantially alter aerodynamic characteristics of the airplane comprising: an insulating layer disposed on a portion of the airplane having a dielectric constant that is sufficiently low, and a thickness that is sufficiently great, to function as a spacing element for the patch antenna; an antenna element disposed on the insulating layer, the antenna element having a size that is related to a frequency of a radio frequency signal that is either received or transmitted by the patch antenna, the antenna element and the insulating layer having a combined thickness that does not substantially alter aerodynamic characteristics of the airplane.

An embodiment of the present invention may further comprise a method of forming a patch antenna on an airplane comprising: placing an insulating layer of an insulating material on at least one surface of the airplane, the insulating layer having a dielectric constant that is sufficiently low and a thickness that is sufficiently great, to function as a spacing element in the patch antenna; providing at least one antenna element on a surface of the insulating layer, the antenna element having a size that is related to a frequency of a radio frequency signal that is either received or transmitted by the patch antenna, and the at least one antenna element and the insulating layer having a combined thickness that does not substantially alter aerodynamic characteristics of the airplane.

An embodiment of the present invention may further comprise a patch antenna that is placed on a body of an airplane that uses the body of the airplane as a ground plane.

An embodiment of the present invention may further comprise a method of placing a patch antenna on a body of an airplane so that the patch antenna uses the body of the airplane as a ground plane.

### BRIEF DESCRIPTION OF THE DRAWINGS

FIG. 1 is a perspective view of an airplane having a plurality of patch antennas.

FIG. 2 is a schematic illustration of a partial cutaway view of a patch antenna system for an airplane.

### DETAILED DESCRIPTION OF THE EMBODIMENTS

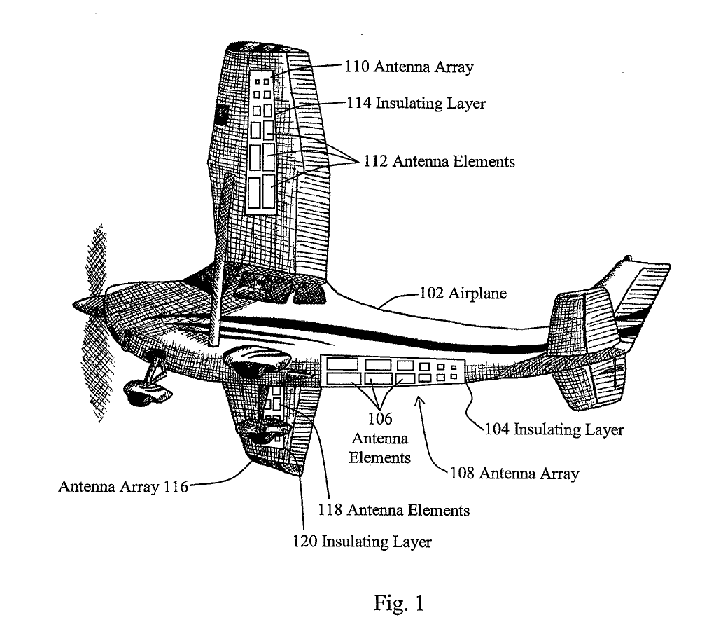

FIG. 1 is a schematic illustration of an airplane 102 that is equipped with a plurality of antenna arrays 108, 110, 116. The antenna arrays 108, 110, 112 each include a plurality of antenna elements. For example, antenna array 108 includes antenna elements 106. Antenna array 110 includes a plurality of antenna elements 112. Antenna array 116 includes a plurality of antenna elements 118. The antenna elements 106, 112, 118 are located on insulating layers 104, 114, 120, respectively.

The insulating layers 104, 114, 120, illustrated in FIG. 1, may comprise a very thin layer of an insulating material having a low dielectric constant. For example, polyimide may be used as the insulating layer 104, 114, 120, since polyimide has a dielectric strength of 3.5, which is very low, and has excellent mechanical properties. For example, polyimides can be thermoplastic or pseudothermoplastic. Polyimides may also be thermosetting and are commercially available as uncured resins, polyimide solutions, stock shapes, thin sheets and laminates. Polyimides can be formed by a reaction between dianhydride and diamine. Polyimides can also be produced by reaction between dianhydride and a diisocyanate. Examples of dianhydrides are pyrometallic dianhydride and naphthalene tetracarboxylic dianhydride. The thermosetting polyimides are known for thermal stability, good chemical resistance, excellent mechanical properties, and a characteristic orangeish, yellow color. Thermoset polyimides exhibit very low creep and high tensile strength. Polyimide laminates have very good heat resistance. Normal operating temperatures for laminates range from cryogenic to over 500° F. Polyimides are inherently resistant to flame combustion. Polyimide laminates have a flexure strength half life at 480° F. of 400 hours. Polyimide is not affected by commonly used solvents, such as oils, including hydrocarbons, esters, ethers, alcohols and freons. They also resist weak acids. Some polyimides are solvent soluble and exhibit high optical clarity. The solubility properties lend these polyimides to spray applications and low temperature cure applications. The polyimide materials are lightweight, flexible, and resistant to heat and chemicals. The semiconductor industry has used polyimide as a high temperature adhesive and as a mechanical stress buffer. Polyimide layers have a good mechanical elongation and tensile strength, which also helps the adhesion between polyimide layers, or between a polyimide layer and a metal layer. Polyimide layers provide a reliable insulation with a low dielectric constant, good adhesion with metal layers that can be sprayed or painted onto a substrate.

Another insulating sheet that can be used that has a low dielectric constant is biaxially-oriented polyethylene terephthalate (BoPET), which is otherwise known as Mylar. BoPET is a polyester film made from stretched polyethylene terephthalate (PET). BoPET has high tensile strength, chemical and dimensional stability, transparency, reflectivity, gas and aroma barrier properties and is an electrical insulator. BoPET (Mylar) has a dielectric constant of 3.1. Biaxially-oriented BoPET film can be metalized by vapor deposition, creating a thin film of evaporated aluminum, gold or other metal. The metalized BoPET film can be laminated with a layer of polyethylene, which provides sealability and improves puncture resistance. Other coatings, such as a conductive indium tin oxide (ITO), can be applied to the BoPET film by sputter deposition. Again, the coated metalized mylar can be attached to the airplane 102 using a contact adhesive, or other curing adhesive, directly onto the desired portion of the body of the airplane 102. The metalized layer that forms the antenna elements 106, 112, 118 can be vapor deposited or sputtered onto a single sheet of mylar, or can be formed in separate individual sheets, for attachment to plane 102. Of course, any plastic sheet, film, or plastic layer can be used as an insulating layer, as long as the plastic sheet, film or layer functions as an insulator and has a sufficiently low dielectric constant, so that the insulating layer functions as an adequate spacing element in a patch antenna.

In that regard, there are a number of other low dielectric insulating materials that can be used as the insulating layers 104, 114, 120, illustrated in FIG. 1. It may be desirable to remove the paint from the portions of the airplane 102 on the areas where the insulating layers 104, 114, 120 are deposited on the aluminum body of the airplane 102 to ensure good adherence. Deposition directly on the aluminum body of airplane 102 may create better adhesion of the insulating layer and also help in establishing the body of airplane 102 as a ground plane. As such, the aluminum body of the airplane functions as a large ground plane for the antenna elements 106, 112, 118. The large ground plane that is the aluminum body of the airplane 102 provides stable electromagnetic patterns and lower environmental sensitivity.

As illustrated in FIG. 1, the insulting layers 104, 114, 120 can be placed on the body of the airplane 102 in the locations indicated in FIG. 1, i.e., on the underbody of the plane, and on the bottom surface of the wings of the airplane 102. The patch antennas 108, 110, 116, illustrated in FIG. 1, can also be used as transmitting, as well as receiving antennas. Antenna arrays, such as antenna arrays 108, 110, 116, can also be placed on the top surfaces of airplane 102 to transmit and receive signals to and from satellites or other objects, such as other airplanes, that are above airplane 102.

The antenna elements 106, 112, 118 of antenna arrays 108, 110, 116, respectively, can be placed on the insulating layers 104, 114, 120 using various techniques. For example, a conductive paint, or conductive cladding, can be sprayed or otherwise applied to the insulating layers 104, 114, 120 to create the antenna elements 106, 112, 118. Various other application techniques can be used to apply the antenna elements 106, 112, 118 to insulating layers 104, 114, 120. In that regard, various masking techniques can be used, including silk screening techniques, for applying the antenna elements 106, 112, 118 to the insulating layers 104, 114, 120. For example, a conductive-type of paint or cladding can be silk screened directly onto the insulating layers 104, 114, 120 to create the conductive antenna elements 106, 112, 118. Various types of paints can be used, that contain conductive materials, such as carbon, copper, or other conductive materials immersed in high concentrations in the paint, so that the painted antenna elements are conductive. Other techniques, such as photolithography, can also be used to form antenna elements 106, 112, 118. Alternatively, the thin insulating layers 104, 114, 120 can be formed in sheets, which can then be coated with the conductive material that forms the antenna elements. Either one single sheet, or a number of individual sheets, can be used for multiple antenna elements. The insulating sheets can be coated with a conductive material to form the antenna elements using various techniques, including sputtering, photo deposition, silk screening, electroplating, painting, or any desired method known to those skilled in the art. The insulating layer sheets 104, 114, 120 may be coated with an adhesive, so that the flexible insulating sheets can be applied directly to the aluminum surface of the airplane. The outside surface of the conductive layers can also be covered to protect the patch antenna.

The antenna elements 106, 112, 118 can form both Euclidean and non-Euclidean shapes. Non-Euclidean shapes can be used to match the surface of the body or wing of the airplane 102. Various curvatures of the conformal antenna elements can be used to match the surfaces of the body and wings of the airplane 102. These curvatures may affect the directionality and shape of the transmitted and received beams. Further, the elements can be formed in various curved, non-Euclidean shapes, including hyperbolic shapes and elliptical shapes. In fact, the antenna elements can take any desired curved shape to match portions of the body and wings and other portions of the airplane 102.

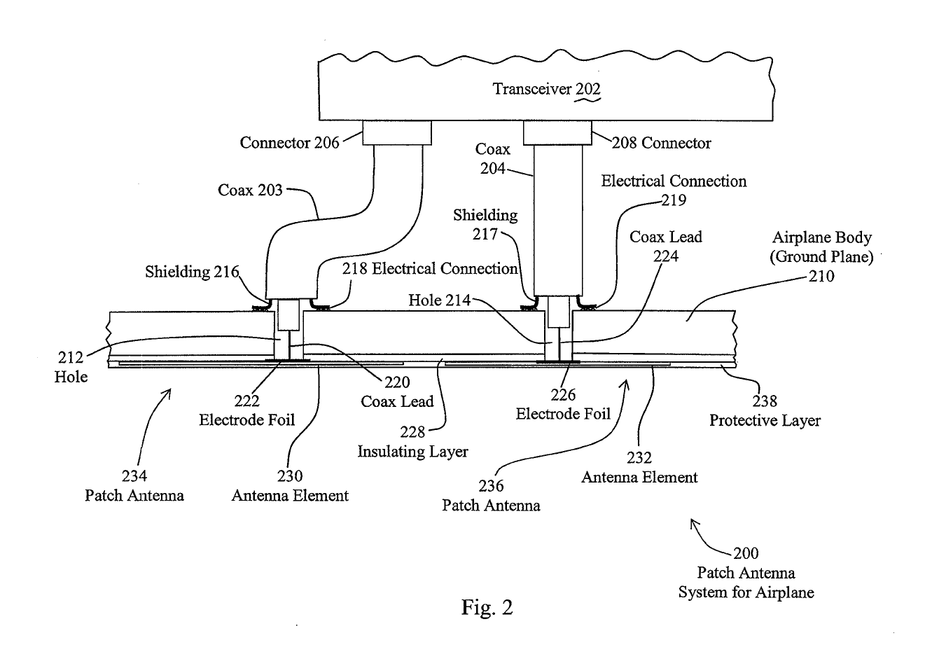

FIG. 2 is a partial cutaway view of a patch antenna system 200 for the airplane 102, as illustrated in FIG. 1. As shown in FIG. 2, a transceiver 202 receives signals from the antenna elements 230, 232 via coax 203, 204 of patch antenna 234 and patch antenna 238, respectively. Coax 203 is connected to the transceiver 202 by connector 206. Coax 204 is connected to the transceiver 202 via connector 208. Coax 203 includes a shielding 216 that is connected via an electrical connection 218 to the airplane body 210. Airplane body 210 functions as a large ground plane for patch antenna 234. Similarly, shielding 217 of coax 204 is connected via electrical connection 219 to the airplane body 210, which functions as a ground plane for patch antenna 236. The coax lead 220 of coax 203 extends through a hole 212 in the airplane body 210 and is electrically connected to an electrode foil 222. The hole 212 also extends through the insulating layer 228 that is disposed directly onto the airplane body 210. Alternatively, the insulating layer 228 may be disposed directly over a paint layer on the airplane body 210. Coax lead 224 extends through hole 214 in the airplane body 210 and the insulating layer 228. Coax lead 224 is electrically connected to electrode foil 226. Antenna element 230 is disposed directly on electrode foil 222, so that an electrical connection is formed between the electrode foil 222 and the antenna element 230. Similarly, antenna element 232 is disposed directly on electrode foil 226. In this manner, antenna element 232 is mechanically and electrically connected to electrode foil 226. Accordingly, transceiver 202 is electrically connected to antenna element 230 of patch antenna 234 and is electrically connected to antenna element 232 of patch antenna 236, such that the transceiver 202 receives RF signals detected by patch antennas 234, 236. A non-conductive, low dielectric constant, epoxy material (not shown) can be used to fill the holes 212, 214 in the airplane body 210.

Patch antennas, such as patch′antennas 234, 236, are also known as rectangular microstrip antennas. Patch antennas are a type of radio frequency antenna that has a low profile. As illustrated in FIG. 2, patch antennas 234, 236 are extremely low profile and can essentially have a thickness equivalent to just several layers of paint. For example, the insulating layer 228 may either constitute a thin film that is applied as a spray-on layer, or a film that is attached to the airplane 102 using an adhesive. Further, the antenna elements 230, 232 may constitute a metallic paint or deposited layer on the insulating layer 228. In either case, the combination of the insulating layer 228 and the antenna elements 230, 232 is equivalent to a thickness of only several layers of paint, does not have sufficient weight, and, as such, does not noticeably or significantly change the aerodynamic characteristics of the airplane 102. Protective layer 238 is also equivalent to a single layer of paint and does not noticeably or significantly alter the aerodynamic characteristics of the airplane body. Protective layer 238 is a non-conductive insulator that protects the antenna elements 230, 232 and has a low dielectric constant to allow RF signals to penetrate the protective layer 238, so that antenna elements 230, 232 can receive the RF signals.

The patch antennas disclosed in FIGS. 1 and 2 are essentially microstrip antennas that are described by Howell, “Microstrip Antennas,” IEEE Instructional Symposium on Antennas and Propagation, Williamsburg, Va., 1982, pp. 177-180, which is specifically incorporated herein for all that it discloses and teaches. The antenna elements function together with the ground plane of the antenna body 218 to form a resonant microstrip transmission line that has a length of approximately ½ wavelength of received or transmitted radio waves. The radiation mechanism arises from the edges of the antenna elements 230, 232 that form the microstrip transmission line. Received or transmitted RF signals cause currents to flow along the surface of the antenna elements 230, 232, which causes the radiation to be either received or transmitted at the edges, where the current intersects the edges of the antenna elements 230, 232 at a wavelength that is slightly larger than the half wavelength of the antenna element. Patch antennas, such as patch antennas 234, 236, transmit and receive linearly polarized RF signals. In that regard, it is desirable to construct a patch antenna, such as patch antennas 234, 236, that have the same polarization as the received signals. The openings which are formed between the edges that intersect the current flow along the antenna elements 230, 232 and the ground plane (airplane body) create the transmission and reception slots of the microstrip that forms the patch antenna. The edges that function as the microstrip slots can be modeled as two resonant dipole antennas that are spaced at a predetermined distance, which is the length of the antenna elements 230, 232 that corresponds to the resonant frequency of the half wave of the radiated or received signal. There is approximately a 7-9 dB gain in the orthogonal direction of the antenna element of patch antennas 234, 236, depending on the shape of the antenna element and the size of the back plane. The back plane, which is in this instance the airplane body 218, is very large, which helps to increase the dB gain of the antenna. Typical patch antennas have a beam width of approximately 65 degrees. However, the lower the dielectric constant of the insulating material, as well as the smaller the distance between the antenna element and the ground plane, i.e., the thickness of the insulating material, the higher the Q of the antenna. As the Q of the patch antenna increases, the directivity of the transmitted and received signals narrows. In addition, the bandwidth of the patch antenna also narrows. The fractional bandwidth of the antenna is linearly related to the spacing between the antenna element and the ground plane. To achieve greater bandwidths for high Q patch antennas, slots can be formed in the antenna elements 230, 232, which affect the flow of current along the surface of the antenna. These slots increase the bandwidth, even though the patch antenna has a high Q. The location, size and direction of the slots increase the bandwidth in ways that are well-known to those skilled in the art of patch antennas.

Patch antennas inherently provide structures that can easily operate at microwave frequencies. For example, half wavelength antennas for 110 MHz are approximately 1.3 meters, which results in an antenna element which is slightly less than approximately 1.3 meters. A 4 GHz radio wave has a half wavelength of approximately 7.5 cm, which results in an antenna element that is slightly less than 3.75 cm. Accordingly, the physical size and shape of the antenna elements is such that the antenna elements can be easily formed using simple screening or masking techniques, in the manner described above. While square shaped antenna elements create a linearly polarized beam, rectangular shaped antenna elements create a beam that is fan shaped. The bandwidths of a fan beam created by a rectangular shaped antenna element vary from the orthogonal to the parallel direction of the antenna element. Circular polarization of a patch antenna can be created by having two feeds on adjacent sides of the antenna element using phased delayed signals. For example, a 90° hybrid coupler can be used to create a 90° phase shift in one of the orthogonal signals. In addition, various types of polarization can be created, including circular polarization, by the addition of slots in the antenna element. For example, a diagonal slot in an antenna element may create circular polarization by the redirection of current along the surface of the antenna element. Circularly shaped antenna elements may assist in creating circular polarization using these diagonally oriented slots. A circular antenna element having a single feed will create linear polarized radiation. If a circular antenna element is perturbed into an ellipse and fed properly, a circular antenna can create circularly polarized electromagnetic waves with a single feed.

Further, by coupling multiple antennas at the same frequency in the multiple antenna arrays, additional directivity can be achieved. In that regard, the phase of each of the antennas at the same frequencies can be adjusted to adjust the directivity of the combined beam in a manner similar to phased array antennas, so that the directional beam or lobe of the three different antennas at the same frequency form an array that can be directed and moved in accordance with the desired direction of the antenna beam. For example, the half wave 1.3 meter antenna elements in each of the antenna arrays 108, 110, 116 may be phase adjusted so that the combined signal forms a lobe that is directed in a forward-looking direction to monitor transmissions that emanate from the forward path of the direction of flight of the plane. Restricted air space exists in various geographical locations, and planes cannot fly into these restricted air spaces. The lobe of the combined beam can be directed to the side of the plane, so that the plane can fly adjacent to a restricted airspace and still detect radio frequency emissions from within the restricted air space. Again, this is simply done by adjusting the phases of the signals received by the antennas having the same frequency in the various antenna arrays, so that the combined beam has a lobe that is directed in the desired direction. Transmitted waves can also be directed in this manner.

Accordingly, simple patch antennas, such as patch antenna 234 and patch antenna 236, can be fabricated on the surface of an airplane using inexpensive techniques that have an extremely low profile that does not significantly affect the aerodynamic shape and qualities of the airplane 102. In that regard, any slight change in the thickness of the surface of an airplane may slightly affect the aerodynamic qualities of the airplane. Accordingly, it cannot be said that patch antenna do not affect the aerodynamic qualities of the airplane at all, since very slight changes may cause these changes. For example, re-painting a plane may affect the aerodynamic qualities of a plane. These aerodynamic effects may not even be detectable by a pilot, since they are so slight. On the other hand, thicker patch antennas may more significantly affect the aerodynamics of an airplane, especially if the patch antennas are placed on an important aerodynamic surface, such as the upper or lower portions of the wing. Accordingly, the term not “substantially” is used to indicate that some aerodynamic effect may be created by the patch antenna, and some effects may or may not be noticeable. However, the term not “substantially” does not include effects that are so great that the aerodynamic characteristics of a plane would cause the plane to be unflyable.

The patch antennas disclosed herein do not have significant weight and do not substantially or significantly affect the aerodynamic characteristics of the airplane 102. These patch antennas can be easily modified to transmit and receive various types of polarized microwave signals at a wide range of frequencies using an extremely low cost structure. The airplane 102 is ideally suited for the patch antenna structure, since the airplane body creates a large ground plane that increases the directivity and the gain of the patch antenna.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A patch antenna on an airplane that does not substantially alter aerodynamic characteristics of said airplane comprising:
an insulating layer disposed on a portion of said airplane having a dielectric constant that is sufficiently low, and a thickness that is sufficiently great, to function as a spacing element for said patch antenna;
an antenna element disposed on said insulating layer, said antenna element having a size that is related to a frequency of a radio frequency signal that is either received or transmitted by said patch antenna, said antenna element and said insulating layer having a combined thickness that does not substantially alter aerodynamic characteristics of said airplane.

2. The patch antenna of claim 1 wherein said size of said antenna element is approximately one-half wavelength.

3. The patch antenna of claim 2 wherein said insulating layer has a dielectric constant of approximately three and a thickness that is at least approximately 0.010 inches thick.

4. The patch antenna of claim 1 wherein said portion of said airplane comprises a body portion.

5. The patch antenna of claim 1 wherein said portion of said airplane comprises a wing portion.

6. The patch antenna of claim 4 wherein said body portion is a lower body portion of said airplane.

7. The patch antenna of claim 4 wherein said body portion is an upper body portion of said airplane.

8. The patch antenna of claim 5 wherein said wing portion is a lower wing portion.

9. The patch antenna of claim 5 wherein said wing portion is an upper wing portion.

10. A method of forming a patch antenna on an airplane comprising:
placing an insulating layer of an insulating material on at least one surface of said airplane, said insulating layer having a dielectric constant that is sufficiently low and a thickness that is sufficiently great, to function as a spacing element in said patch antenna;
providing at least one antenna element on a surface of said insulating layer, said antenna element having a size that is related to a frequency of a radio frequency signal that is either received or transmitted by said patch antenna, and said at least one antenna element and said insulating layer having a combined thickness that does not substantially alter aerodynamic characteristics of said airplane.

11. The method of claim 10 wherein said process of placing an insulating layer of an insulating material on at least one surface of said airplane comprises placing an insulating layer of said insulating material on at least one surface of said airplane that is at least approximately 0.010 inches thick.

12. The method of claim 10 wherein said process of placing an insulating layer of insulating material on at least one surface of said airplane comprises:
spraying an insulating layer of insulating material on at least one surface of said airplane.

13. The method of claim 10 wherein said process of providing at least one antenna element comprises:
painting said at least one antenna element using conductive paint on said insulating layer.

14. The method of claim 10 wherein said process of providing at least one antenna element comprises:
spraying a conductive cladding on said insulating layer to provide at least one antenna element.

15. The method of claim 10 wherein said method of providing at least one antenna element on a surface of said insulating layer and placing an insulating layer on a surface of said airplane comprises:
depositing an electrically conductive coating on an insulating film;
attaching said insulating film on said surface of said airplane with an adhesive.

16. The method of claim 15 wherein said adhesive is a contact adhesive.

17. The method of claim 15 wherein said adhesive is a curing adhesive.

18. A patch antenna that is placed on a body of an airplane that uses said body of said airplane as a ground plane.

19. A method of placing a patch antenna on a body of an airplane so that said patch antenna uses said body of said airplane as a ground plane.
